(19) United States
(12) Patent Application Publication
(10) Pub. No.: US 2014/0263054 A1
(43) Pub. Date: Sep. 18, 2014

(54) Water Purification System

(71) Applicant: Water Safety Corporation, (US)

(72) Inventors: John Jay Julos, Reno, NV (US); Michael Parise, Reno, NV (US)

(73) Assignee: Water Safety Corporation, Reno, NV (US)

(21) Appl. No.: 13/838,069

(22) Filed: Mar. 15, 2013

(51) Int. Cl. C02F 1/00; C02F 1/28; C02F 1/44; C02F 1/42

(52) U.S. Cl. CPC C02F 1/003; C02F 1/42; C02F 1/283; C02F 1/444
USPC 210/636; 210/266; 210/263; 210/282; 210/287

(57) ABSTRACT

Technology is described for a water purification system. The water purification may include a carbon block. The water purification system may include an ion-exchange resin layer to reduce a pH level in water before neutral water passes into a fiber membrane filter. The water purification system may include the fiber membrane filter to receive the water from the carbon block and into a plurality of pores to remove suspended solids from the water.

### BACKGROUND

Water purification systems may be used to remove impurities, contaminants, bacteria, and viruses from drinking water. In addition, water purification systems may purify water for a variety of other purposes, such as for irrigation, aquariums, and swimming pools. Water purification systems that may be applicable for home use include faucet filters, filters for refrigerator water lines, water pitchers, and home water dispenser filters. Although municipal water suppliers may adhere to strict regulations governing the purification and quality of the provided to consumers, the water may pick up contaminants between the water treatment facility and the home. For example, old plumbing may introduce lead and other contaminants in the water. Furthermore, municipal water suppliers may add chlorine, fluoride, and other chemicals that may affect the taste of the water.

Water purification systems may reduce impurities in the water, including chlorine, lead, mercury, copper, cysts, pesticides, etc. As a result, water purification systems may improve both the taste and smell of the water. Water purification systems may remove protozoa (approximately 1 micron in size), bacteria (approximately 0.1 microns in size), and viruses (approximately 0.01 microns in size) from the water. In addition, water purification systems may remove impurities from the water using an assortment of techniques, such as physical processes (e.g., filtration, sedimentation, distillation), chemical processes (e.g., flocculation, chlorination), biological processes (e.g., slow sand filters, biologically active carbon), and the use of electromagnetic radiation (e.g., ultraviolet light).

### BRIEF DESCRIPTION OF THE DRAWINGS

FIGS. 1A and 1B illustrate a water purification system according to an example of the present technology.

FIG. 2 illustrates a cross-sectional view of the water purification system according to an example of the present technology.

FIG. 3 is a flowchart of an example method for flushing a water purification system according to an example of the present technology.

### DETAILED DESCRIPTION

Reference will now be made to the examples illustrated in the drawings, and specific language will be used herein to describe the same. It will nevertheless be understood that no limitation of the scope of the technology is thereby intended. Alterations and further modifications of the features illustrated herein, and additional applications of the examples as illustrated herein, which would occur to one skilled in the relevant art and having possession of this disclosure are to be considered within the scope of the description.

This technology provides a water purification system. The water purification system may include a mechanical filtration media, a carbon block, an ion-exchange resin layer, and/or a fiber membrane filter. For example, the water may flow into the mechanical filtration media, through the carbon block and ion-exchange resin layer, and then through the fiber membrane filter (e.g., an ultrafilter) before passing into a drainage basin. The mechanical filtration media, the carbon block, and the fiber membrane filter may be included as separate layers in a multi-layer cartridge or some layers may be combined. Each layer of the multi-layer cartridge may provide an additional level of water purification. For example, the mechanical filtration media may prevent suspended solids contained in the water (e.g., sediment, dirt, rust . . . ) from passing into the carbon block. The carbon block may adsorb dissolved contaminants in the water (e.g., chlorine) and particulates down to 0.5 microns in size.

Water may flow from the carbon block into the fiber membrane filter. The fiber membrane filter may include an ion-exchange resin layer. The ion-exchange resin layer may exchange ions from resin beads included in the ion-exchange resin layer with ions in the water. The ions may be exchanged based on an ion exchange group, such as carboxylic acid (COOH), in order to reduce a pH level of the water. In other words, the ion-exchange resin layer may convert water with an increased pH level (i.e., alkaline water) to water with a decreased pH level (i.e., neutral water). Neutral water may have a pH level of 7, while alkaline water may have a pH level greater than 7. The fiber membrane filter may receive the water with the reduced pH level from the ion-exchange resin layer. The water may pass into a plurality of pores in the fiber membrane filter. The plurality of pores in the fiber membrane filter may block contaminants in the water with a size in a range of 0.01 microns to 0.02 microns. The fiber membrane filter may clog because the increased pH level of the water leaving the carbon block may cause dissolved solids in the water to precipitate out of solution and form solid particles that become stuck in the pores of the fiber membrane filter. With the ion-exchange resin layer reducing the pH level of the water, the fiber membrane filter may experience reduced clogging when the water passes through the plurality of pores in the fiber membrane filter and into the drainage basin. In addition, clogging in the fiber membrane filter may be reduced by rotating the multi-layer cartridge during a flushing process of the carbon block, such that the excess minerals from the carbon block can bypass the fiber membrane filter and fall into the drainage basin.

FIGS. 1A and 1B illustrate a filter 100 for an exemplary water purification system. The water purification system may be attached to a water faucet found in kitchens, used in bathrooms, etc. In other words, the water purification system may be used on a residential water supply. The water purification system can also be used in commercial and industrial applications where pure water is desired. The filter 100 for the water purification system may include a multi-layer cartridge with a plurality of cartridge layers. The cartridge layers may include a mechanical filtration media, a carbon block, an ion-exchange resin layer, and/or a fiber membrane filter. In one configuration, the carbon block, the ion-exchange resin layer, and the fiber membrane filter may be included in a single cartridge and the mechanical filtration media may be a separate cartridge. The cartridge layers may be used to purify the water before flowing into the drainage basin, as will be described in greater detail below.

In some examples, the water purification filter 100 may be mounted onto the water faucet (e.g., a faucet-mount filter), or installed underneath a drainage basin (e.g., an under sink or under counter water filter). Faucet-mounted filters may allow consumers to switch back and forth between filtered or purified and unfiltered water for cooking and drinking. The ability to activate and deactivate the filter may extend the life of the faucet-mount filter. In addition, the water purification system may sit directly on a counter top (e.g., a counter top water filter). Counter top water filters may remove the same impurities from the water as compared with the faucet-mount filters and the under sink water filters.

In one configuration, the water purification system may be included in a water pitcher. The water pitcher may receive water from a source (e.g., a water faucet). The water pitcher may include the multi-layer cartridge with the plurality of cartridge layers, such as the mechanical filtration media, the carbon block, the ion-exchange resin layer, and/or the fiber membrane filter. The water may pass through each cartridge layer in the multi-layer cartridge to remove impurities from the water, wherein each cartridge layer may remove contaminants smaller in size as compared with the previous cartridge layer. The water pitcher may store the purified water until a person is ready to drink the water.

FIG. 2 illustrates a cross-sectional view of the water purification filter 100. The water purification filter 100 may include a carbon block 202, a fiber membrane filter 204, an ion-exchange resin layer 206, and a mechanical filtration media (not shown). The carbon block 202, the fiber membrane filter 204, and the ion-exchange resin layer 206 may be included in a multi-layer cartridge 208 of the water purification filter 100. The multi-layer cartridge 208 may be coupled to the mechanical filtration media. The water purification filter 100 may receive water (e.g., tap water) through the inlet 212, purify the water using the multi-layer cartridge 208, and then return purified water through an outlet 214. In addition, the water purification filter 100 may include a lid 216, a potting material 218 to keep in the hollow fiber membrane filter 204, and a batting 220 to keep resin inside the fiber membrane filter 204 and to keep carbon out of the fiber membrane filter 204.

In one configuration, the ion-exchange resin layer 206 may be within the fiber membrane filter 204, and the fiber membrane filter 204 may be within the carbon block 202. In general, the water may flow through each cartridge in the multi-layer cartridge 208 before flowing into the drainage basin, wherein each cartridge performs an additional level of water purification (e.g., the mechanical filtration media may remove the largest particles, the carbon block 202 may remove a smaller scale of particles, etc.) By combining each cartridge into a multi-layer cartridge 208, the consumer may simply replace the entire multi-layer cartridge 208 at a time, rather than replacing each individual cartridge when the cartridge is spent. Since each individual cartridge may have a different lifespan, replacing each cartridge rather than the multi-layer cartridge 208 may be cumbersome. The multi-layer cartridge 208 may be replaced according to a specified time period (e.g., every 12 months) and/or the amount of water that has been purified (e.g., 1000 gallons).

The water purification filter 100 may include a pressurization housing 210 to hold the multi-layer cartridge 208 using seals and/or fittings. The pressurization housing 210 may direct the flow of water from a source (e.g., a water faucet) through the multi-layer cartridge 208 and to a point of dispensing (e.g., output plumbing). The pressurization housing 210 may restrict the water flow to increase the pressure on the inside of the multi-layer cartridge 208. The increased pressure may drive the water through the tight pore structure of the carbon block 202 and the fiber membrane filter 204.

The mechanical filtration media (also known as a pre-filter) may be the initial filtration media for the water upon entering the water purification filter 100. The mechanical filtration media may provide a physical barrier to block suspended solids that are physically too large to pass through the mechanical filter media. For example, the suspended solids may include dirt, sediment, rust, particles, fibers, etc. The mechanical filter media may capture the suspended solids from the water before the water flows into the carbon block 202. The mechanical filter media may be periodically cleaned and/or replaced to remove the remainder of the filter layers. In addition, the mechanical filtration media may be composed of woven and/or non-woven materials.

The carbon block 202 may receive water from the mechanical filtration media. The water may arrive at the carbon block 202 already having been filtered to remove relatively large suspended solids (e.g., dirt, rust). The carbon block 202 may further remove smaller particles (e.g., particles that are approximately down to 0.5 microns in size) from the water. In general, the carbon block 202 may include a block of activated carbon to remove contaminants and impurities from the water using chemical adsorption. The activated carbon may include carbon composed from cellulosic matter and additional decaying organic materials. The activated carbon may be processed to include a plurality of small, low-volume pores. The small, low-volume pores in the activated carbon may increase the surface area available for adsorption. In other words, the pore structure of the activated carbon may enable the adsorption of dissolved contaminants from the water, such as chlorine, organics, and other trace elements. The activated carbon may be manufactured from carbonaceous material, including coal, charcoal, peat, coir, lignite, petroleum pitch, wood, or nutshells (e.g., coconut). The activated carbon may be processed (i.e., graded, blended, and molded under heat and pressure) to form the carbon block 202. In addition, the carbon block 202 may provide a pore structure that is smaller than loose granular carbon that is often found in water filters. As a result, a smaller pore structure of the pressed and formed carbon block 202 may enable the removal of smaller contaminants in the water as compared with water filters that use loose granular carbon.

The fiber membrane filter 204 may receive the water from the carbon block 202. The fiber membrane filter 204 may be composed from a variety of materials, such as carbon, ceramic material, plastic, and clay. The fiber membrane filter 204 may include a microfilter, an ultrafilter, a nanofilter, or a reverse osmosis (RO) filter. In general, the fiber membrane filter 204 may be hollow, such that water may flow through the outside of the hollow fiber, and then collect on the inside of the hollow fiber. The type of fiber membrane filter 204 may depend on a pore size of the fiber membrane filter 204. For example, a pore size of approximately 0.1 to 0.2 microns may indicate a microfilter, whereas a pore size of 0.01 to 0.02 microns may indicate an ultrafilter. The nanofilter and the RO filter may include a pore size of less than 0.01 microns. The pore size of an ultrafilter (i.e., 0.01 to 0.02 microns) may enable the blockage of suspended solids as small as 0.02 microns. The size of 0.02 microns may be approximately ten times smaller than bacteria and in the size range of viruses, which are generally the smallest known microbial contaminants that are waterborne. For example, viruses may be in the size range of 0.018 microns to 0.1 microns. In other words, viruses may be in the size range of 18 nanometers (nm) to 100 nm. The fiber membrane filter 204 may have a pore size of at least 0.01 microns in order to successfully remove viruses from the water. Thus, the ability of the fiber membrane filter 204 to act as a barrier for viruses may produce purified water that is microbiologically safe. However, dissolved solids (e.g., salts, minerals) may pass through the plurality of pores in the fiber membrane filter 204.

In one configuration, the fiber membrane filter 204 may be an ultrafilter. The ultrafilter may offer numerous benefits as opposed to other filter technologies (e.g., chlorination, ultraviolet light). For example, the ultrafilter may not employ heat in contrast to a distiller. The ultrafilter may not require electricity, as with water filters that utilize ultraviolet (UV) light. In addition, the ultrafilter may not use chemicals, such as chlorine and other oxidants. In other words, the ultrafilter may offer a non-electric, non-chemical, and non-heat solution to removing viruses, bacteria and other contaminants from the water.

The fiber membrane filter 204 may include an ion-exchange resin layer 206 containing resin. For example, the water from the carbon block 202 may enter the ion-exchange resin layer 206 before passing through the fiber membrane filter 204. The resin may be in the middle of the fiber membrane filter 204 and/or on the edge of the fiber membrane filter 204. The ion-exchange resin layer 206 may reduce a pH level of water flowing from the carbon block 202. Subsequently, the ion-exchange resin layer 206 may deliver the water with the reduced pH level to the fiber membrane filter 204. As will be discussed in greater detail below, the carbon block 202 may increase the pH level of the water.

The ion-exchange resin layer 206 may reduce the pH level of the water leaving the carbon block 202 in order to reduce clogging of the fiber membrane filter 204. Otherwise, the increased pH level of the water leaving the carbon block 202 may cause dissolved solids in the water to precipitate out of solution and form solid particles. The solid particles formed in the water may be large enough (e.g., 1-2 microns) to clog the pores in the fiber membrane filter 204. The range of 1-2 microns may be approximately 100 times larger than the pore size of the fiber membrane filter 204. As a result, the pores in the fiber membrane filter 204 may clog over time, as the average size of the solid particles passing through the fiber membrane filter 204 may exceed the pore size. In addition, the fiber membrane filter 204 may clog as a result of operating in a dead end mode. In other words, the ability for the particles to pass through the fiber membrane filter 204 may decrease over time with the continuous build-up of particles larger than the pore size.

Therefore, the ion-exchange resin layer 206 may reduce the pH level of the water in order to decrease the number of particles that may get stuck in the fiber membrane filter 204. The addition of the ion-exchange resin layer 206 may increase the life span of the fiber membrane filter 204 (e.g., from 500 gallons to 1000 gallons or more). As a result, the frequency at which the multi-layer cartridge 208 (which includes the fiber membrane filter 204) is replaced may be reduced (e.g., from 6 months to 12 months). Since the ion-exchange resin layer 206 may reduce clogging in the plurality of pores in the fiber membrane filter 204, a steady flow of water may be maintained. For example, the flow of the water may generally be about 0.4 to 0.5 gallons per minute (GPM) at a water pressure of 60 pounds per square inch (psi). In contrast, a fiber membrane filter 204 that is clogged may produce a smaller flow of water (e.g., 0.3 GPM).

The carbon block 202 may increase the pH level of the water due, in part, to the carbon activation process. The surface of carbon following the carbon activation process may contain active sites with attached chemical groups. The chemical groups may release hydrogen, hydroxide, and other ions into water that flow through the carbon. The balance of the ions may determine the pH level of the water. For example, if the balance shifts towards more hydroxide ions, the pH level of the water may increase and result in alkaline water.

The chemical groups on the surface of the carbon may be manipulated to change the resulting pH level of the water. For example, the carbon may be acid washed after the carbon activation process. In addition, washing the carbon may remove mineral ash from the carbon, which may increase the alkalinity of the water. The effectiveness of washing the carbon may vary according to the process design and/or the time constraints of the wash. In addition, the effectiveness of the washing may depend on whether a small mesh or a large mesh is used during the washing process. For example, the carbon may be handled with greater ease when using the large mesh. In addition, the large mesh size may result in less carbon being lost during the carbon activation process. In contrast, a small mesh may result in increased difficulty when handling the carbon. Furthermore, the small mesh size may result in an increased amount of carbon being lost during the washing process. The carbon may be washed from the outside after being placed in the small mesh or the large mesh. If the carbon is left to soak for an inadequate period of time and/or the pressure used to wash the carbon is inadequate, a portion of the carbon surface may be unwashed.

Following the carbon activation process, the carbon block 202 may contain excess minerals, such as calcium, magnesium, potassium, etc. In general, the excess minerals may be flushed from the carbon block 202 when the customer beings to use the water purification filter 100. In other words, the particles from the minerals may be small enough to pass through the pores of the fiber membrane filter 204 when the water is neutral (i.e., the water has a pH level of approximately seven). In this example, the pH level of the water entering the carbon block 202 may be approximately the same pH level of the water leaving the carbon block 202.

However, a complication may arise when the carbon is either graded to a small mesh size and/or suffers an abrasion through transport, blending, or other handling issues that result in damage to the carbon. The carbon block 202 may be composed from a small mesh carbon that is blended with a binder (e.g., polyethylene or a similar material). The grinding of the larger grain and the processing may expose additional surfaces on the carbon. As a result, the additional surfaces on the carbon may increase the pH level of water flowing through the carbon block 202. If the pH level of the water reaches approximately 9.5 to 10, dissolved solids (e.g., salt) from the water may precipitate and form particles. As previously explained, these particles may be too large to pass through the fiber membrane filter 204 without clogging. Therefore, the minerals from the carbon block 202 (e.g., calcium, magnesium, potassium) that may ordinarily pass through the fiber membrane filter 204 without clogging when the water is neutral may be unable to pass through the fiber membrane filter 204 without clogging when the water is alkaline.

In order to resolve the problems associated with using carbon manufactured from a small mesh size and/or carbon that has formed additional surfaces through the carbon activation process, methodologies to minimize the pH level of the water may be necessary to prolong the service life of the fiber membrane filter 204. In one example, flushing the carbon block 202 may reduce the pH level of the water before the water enters the fiber membrane filter 204. Flushing may be a procedure carried out by the consumer at the time of installation. After flushing the carbon block 202, an increase in the pH level of the water during the initial use of the carbon block 202 may cause minimal clogging in the fiber membrane filter 204. Furthermore, the pH level of the water leaving the carbon block 202 may be neutral or approximately the pH level of the tap water after the carbon block 202 is flushed. The typical flushing time for the carbon block 202 may be approximately 15 minutes, during which time about 10 gallons of water may pass through the water purification filter 100. Depending on the water chemistry and other conditions, the 15-minute period may be adequate to stabilize the pH of the water, such that no or minimal precipitation of solids are formed. A flushing period of greater than 15 minutes may be impractical, a waste of water, and a nuisance to the customer.

Since the fiber membrane filter 204 may be located within the carbon block 202 (i.e., the fiber membrane filter 204 may be downstream from the carbon block 202), then flushing the carbon block 202 may result in particles from the carbon block 202 being captured by the fiber membrane filter 204. As previously discussed, the lifespan of the fiber membrane filter 204 may be reduced when particles from the carbon block 202 clog the fiber membrane filter 204. Therefore, the carbon block 202 may be flushed by rotating the multi-layer cartridge 208, such that water from the carbon block 202 may bypass the fiber membrane filter 204 and flow directly into the drainage basin. Once the carbon block 202 is flushed, the multi-layer cartridge 208 may be rotated back to its previous position. In other words, the alkaline water flowing from the carbon block 202 may avoid flowing through the fiber membrane filter 204 altogether, thereby avoiding pre-mature clogging of the fiber membrane filter 204 during the carbon flushing process. As a result, flushing of the carbon block 202 may result in relatively few (or none) of the pores in the fiber membrane filter 204 being clogged.

In one configuration, the ion-exchange resin layer 206 may use a weak acid cation (WAC) exchange resin to reduce the pH level of the water leaving the carbon block 202. In other words, the ion-exchange resin layer 206 may convert alkaline water leaving the carbon block 202 into neutral water. The ion-exchange resin layer 206 may exchange ions from resin beads included in the ion-exchange resin layer 206 for ions in the water. The ions from the resin beads may be exchanged for ions in the alkaline water based on an ion exchange group. For example, the ion exchange group may include carboxylic acid (COOH). The surface of the resin beads may be saturated with COOH. When a counter ion (e.g., a calcium ion) in the alkaline water comes into contact with the resin bead, the hydrogen on the COOH may be exchanged for the calcium ion. In fact, two hydrogen ions may be released for each calcium ion in order to maintain charge balance. The addition of the additional hydrogen ions to the alkaline water may drive the pH level of the water towards an acidic condition (i.e., a pH level of below 7). In other words, the additional hydrogen ions may counteract the increased pH level of the water leaving the carbon block 202. Therefore, the resin beads may keep the pH level of the water from increasing while excess minerals are being flushed from the carbon block 202. Additionally, the ion-exchange resin layer 206 may use a small quantity of a strong acid (e.g., hydrochloric acid) to reduce the pH level of the water leaving the carbon block 202.

In one example, the carbon block 202 may be flushed before allowing the resin to further stabilize the pH level of the water. For example, flushing the excess minerals from the carbon block 202 and rotating the multi-layer cartridge 208 may avoid the excess minerals from clogging the fiber membrane filter 204. The flushing of the carbon block 202 may stabilize the pH level of the water. Furthermore, the ion-exchange resin layer 206 may prevent dissolved particles from the carbon block 202 from forming into larger particles that may clog the fiber membrane filter 204.

FIG. 3 is a flowchart for an example method of flushing the water purification filter 100. The method may include the operation of running water through a multi-layer cartridge within the water purification system, wherein the water runs through a carbon block and an ultrafilter before passing into a drainage basin, as in block 310. For example, water may originate from a source (e.g., a water faucet), flow through the multi-layer cartridge, and then drain into a basin. The multi-layer cartridge may include the carbon block and the ultrafilter. The ultrafilter may include an ion-exchange resin layer. In addition, the carbon block may include the ultrafilter. In one configuration, the multi-layer cartridge may be coupled to a mechanical filtration media.

The multi-layer cartridge may be rotated within the water purification filter, wherein the multi-layer cartridge has been rotated to position the carbon block upstream from the ultrafilter, as in block 320. In other words, the multi-layer cartridge may be rotated to prevent water from flowing from the carbon block into the ultrafilter. By bypassing the ultrafilter, particles from the water may not prematurely clog the ultrafilter. In addition, the rotated multi-layer cartridge may be held inside pressurization housing. The pressurization housing may provide force to flush the water through each cartridge in the multi-layer cartridge and into the drainage basin.

The water may be flushed through the rotated multi-layer cartridge for a predefined period of time, and the water may flush mineral content from the carbon block and bypass the ultrafilter before passing into the drainage basin, as in block 330. The water may bypass the ultrafilter before flowing into the drainage basin in order to reduce clogging of the ultrafilter caused by mineral content flushed from the carbon block. The carbon block may be flushed in order to wash away mineral content resulting from the carbon activation process. Once the carbon block is flushed, the multi-layer cartridge may be rotated back to its previous position.

The described features, structures, or characteristics may be combined in any suitable manner in one or more examples. In the preceding description, numerous specific details were provided, such as examples of various configurations to provide a thorough understanding of examples of the described technology. One skilled in the relevant art will recognize, however, that the technology can be practiced without one or more of the specific details, or with other methods, components, devices, etc. In other instances, well-known structures or operations are not shown or described in detail to avoid obscuring aspects of the technology.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements can be devised without departing from the spirit and scope of the described technology.

What is claimed is:

1. A water purification filter, the filter including:
a mechanical filtration media to prevent suspended solids contained in water from passing through the mechanical filtration media;
a carbon block to absorb dissolved contaminants from the water received from the mechanical filtration media, the carbon block being composed of activated carbon;
an ion-exchange resin layer to reduce a pH level of the water; and
an ultrafilter that receives the water with a reduced pH from the ion-exchange resin layer into a plurality of pores to block suspended solids in the water.

2. The water purification filter of claim 1, wherein the ion-exchange resin layer exchanges ions from resin beads included in the ion-exchange resin layer for ions in the water.

3. The water purification filter of claim 2, wherein the ions from the resin beads are exchanged for ions in the water based on an ion exchange group including carboxylic acid (COOH).

4. The water purification filter of claim 3, wherein hydrogen ions contained in the resin beads are exchanged for ions in the water based on the ion exchange group having COOH, and the addition of the hydrogen ion to the water reduces the pH level of the water.

5. The water purification filter of claim 1, wherein the ultrafilter is within the carbon block.

6. The water purification filter of claim 1, further comprising a pressurization housing to hold the carbon block and the ultrafilter, the pressurization housing providing force to push the water through the carbon block and the ultrafilter.

7. The water purification filter of claim 1, wherein the plurality of pores in the ultrafilter have a pore size in the range of 0.01 microns to 0.02 microns.

8. A water purification filter, comprising:
a carbon block;
an ion-exchange resin layer to reduce a pH level in water before neutral water passes into a fiber membrane filter; and
the fiber membrane filter to receive the water from the carbon block and into a plurality of pores to remove suspended solids from the water.

9. The water purification filter of claim 8, wherein pH reduced water reduces clogging of the fiber membrane filter as compared to alkaline water which increases clogging of the fiber membrane filter.

10. The water purification filter of claim 8, wherein the fiber membrane filter is: a microfilter, an ultrafilter, a nanofilter, or a reverse osmosis (RO) filter.

11. The water purification filter of claim 8, wherein the fiber membrane filter is within the carbon block to form a multi-layer cartridge.

12. The water purification filter of claim 8, wherein the carbon block is composed of activated carbon.

13. The water purification filter of claim 8, wherein the water with a reduced pH has a pH level of approximately seven and incoming alkaline water has a pH level of greater than seven.

14. The water purification filter of claim 8, further comprising a mechanical filtration media composed from woven and non-woven materials, the mechanical filtration media providing a physical barrier to prevent suspended solids contained in water that passes through the mechanical filtration media into a carbon block;

15. The water purification filter of claim 8, further comprising a pressurization housing to hold the carbon block and the fiber membrane filter, the pressurization housing providing force to push the water through the carbon block and the fiber membrane filter.

16. The water purification system of claim 8, wherein the fiber membrane filter is composed of one of the following: carbon, a ceramic material, plastic, and clay.

17. A method for flushing a water purification filter, the method comprising:
running water through a multi-layer cartridge within the water purification system, wherein the water runs through a carbon block and an ultrafilter before passing into a drainage basin;
rotating the multi-layer cartridge within the water purification filter, wherein the multi-layer cartridge has been rotated to position the carbon block upstream from the ultrafilter; and
flushing water through the rotated multi-layer cartridge for a predefined period of time to flush mineral content from the carbon block and bypass the ultrafilter before passing into the drainage basin.

18. The method of claim 17, wherein bypassing the ultrafilter before passing into the drainage basin reduces clogging of the ultrafilter caused by the mineral content flushed from the carbon block.

19. The method of claim 17, wherein a pressurization housing holds the rotated multi-layer cartridge with the ultrafilter and the carbon block, the pressurization housing providing force to flush the water through the carbon block and into the drainage basin.
